(19) United States
(12) Patent Application Publication
(10) Pub. No.: US 2018/0366089 A1
(43) Pub. Date: Dec. 20, 2018

(54) HEAD MOUNTED DISPLAY COOPERATIVE DISPLAY SYSTEM, SYSTEM INCLUDING DISPAY APPARATUS AND HEAD MOUNTED DISPLAY, AND DISPLAY APPARATUS THEREOF

(71) Applicant: MAXELL, LTD., Kyoto (JP)

(72) Inventors: Takaaki SEKIGUCHI, Tokyo (JP); Takashi MATSUBARA, Tokyo (JP); Takashi KANEMARU, Tokyo (JP); Naokazu UCHIDA, Tokyo (JP); Masaki WAKABAYASHI, Tokyo (JP); Naoki MORI, Tokyo (JP)

(21) Appl. No.: 16/063,208

(22) PCT Filed: Dec. 18, 2015
(86) PCT No.: PCT/JP2015/085595

§ 371 Date: Jun. 15, 2018

(51) Int. Cl. G09G 5/12; G06F 3/14; G09B 5/02

(52) U.S. Cl. CPC G09G 5/12; G06F 3/1423; G10L 15/265; G09G 2354/00; G09B 5/02

(57) ABSTRACT

The purpose of the present invention is to appropriately display secondary information on a head-mounted display in relation to primary information displayed on a main display device even when a wearer moves or takes their eyes off the main display device. In order to achieve the above purpose, this collaborative head-mounted display system calculates the positional information of the head-mounted display wearer's gaze with respect to the primary information from a camera image acquired from the head-mounted display and the position of the head-mounted display wearer's gaze with respect to the camera image. The collaborative head-mounted display system then selects and displays the secondary information associated with the calculated positional information, and changes how the secondary information is displayed depending on whether or not the wearer is looking at the primary information.

### TECHNICAL FIELD

The present invention relates to a display system and a display apparatus using a head mounted display (HMD).

### BACKGROUND ART

A technique of displaying second information (hereinafter referred to as “secondary information”) related to first information (hereinafter referred to as “primary information”) displayed on a main display apparatus on a head mounted display (hereinafter “HMD”) has been proposed.

As a background technique of the present technical field, there is a technique disclosed in JP 2001-215920 A (Patent Document 1). A technique of displaying the secondary information related to the primary information present in a direction of the head of the wearer or a line of sight direction which is detected by the HMD in accordance with the direction when an HMD wearer browses the primary information displayed on a screen of the main display apparatus is disclosed in Patent Document 1. With this technique, since the information (primary information) displayed on the main display apparatus is reduced, the size of the apparatus can be prevented from increasing, and since the wearer can check necessary information (secondary information) by moving the head or the line of sight, operability of the apparatus can be improved.

Further, there is a technique disclosed in JP 2010-237522 A (Patent Document 2). A technique of displaying secondary information at an appropriate position adjacent to primary information on the basis of a positional relation between a wearer's seat and a screen when an HMD wearer browses the primary information projected on a large screen is disclosed in Patent Document 2. With this technique, it is possible to display subtitles (secondary information) corresponding to a mother tongue so that only the HMD wearer can see the subtitles when watching a movie (primary information).

### CITATION LIST

### Patent Document

Patent Document 1: JP 2001-215920 A

Patent Document 2: JP 2010-237522 A

### SUMMARY OF THE INVENTION

### Problems To Be Solved by the Invention

In the technique disclosed in Patent Document 1, the secondary information of information present at a staring point of the wearer detected by the HMD is displayed. However, the staring point detected by the HMD indicates a position in the field of view of the wearer. In other words, since the field of view includes a surrounding landscape in addition to the primary information displayed by the main display apparatus, and the wearer does not necessarily face the front of the main display apparatus, the primary information has a different shape depending on the position of the wearer. Therefore, in order to detect an object inside the primary information at which the wearer stares, it is necessary to convert the staring point detected by the HMD into coordinates in the primary information by a certain device, but the device is not disclosed in Patent Document 1.

Further, in the technique disclosed in Patent Document 2, a display position of the secondary information in the HMD is calculated by performing coordinate conversion on the basis of the positional relation between the wearer's seat and the screen, but in a case in which the wearer leaves the seat and browses the primary information at a different position, it is unable to be dealt with.

Further, in both of the techniques disclosed in Patent Documents 1 and 2, the secondary information is displayed only while the wearer is browsing the primary information, the wearer is unable to browse the secondary information if the wearer looks away from the primary information.

The present invention was made in light of the above-described problems, and it is an object of the present invention to provide a mechanism capable of displaying the secondary information of the primary information displayed on the main display apparatus on the HMD appropriately even when the wearer of the HMD moves or looks away from the main display apparatus.

### Solutions to Problems

In order to solve the above problem, the present invention provides a system including a display apparatus and a head mounted display, wherein the display apparatus includes a first display that is capable of displaying an image or a projecting unit that is capable of projecting an image, and a first communication unit that is capable of performing communication with the head mounted display, the head mounted display includes a second display configured to display an image which is viewed by a wearer of the head mounted display, a line of sight detector configured to detect a line of sight direction of the wearer of the head mounted display, and a second communication unit that is capable of performing communication with the display apparatus, a staring point detector configured to detect a position of a staring point of a line of sight of the wearer of the head mounted display with respect to the image displayed by the first display of the display apparatus or the image projected by the projecting unit on the basis of information transmitted and received via the first communication unit and the second communication unit is installed in either of the display apparatus and the head mounted display, the staring point detector calculates position information in the image corresponding to the position of the staring point when the staring point is on the image, and the head mounted display acquires relevant data related to target data displayed at the calculated position in the image by means of the communication with the display apparatus or other communication and displays the relevant data on the second display.

### Effects of the Invention

According to the present invention, there is an effect in that it is possible to increase freedom of a behavior of the wearer of the HMD and browse the secondary information in a more natural manner since it is possible to select and display appropriate secondary information regardless of a position or a direction of the line of sight of the wearer of the HMD.

### BRIEF DESCRIPTION OF THE DRAWINGS

FIG. 1 is a diagram illustrating an operation overview of an HMD cooperative display system in a first embodiment.

FIG. 2 is an overall configuration diagram of the HMD cooperative display system in the first embodiment.

FIG. 3 is a configuration diagram of a primary information database in the first embodiment.

FIG. 4 is a configuration diagram of a secondary information database in the first embodiment.

FIG. 5 is a diagram for describing a primary information selection manipulation in the first embodiment.

FIG. 6 is a flowchart of a primary information selection process in the first embodiment.

FIG. 7 is a diagram for describing a camera image and an in-camera image staring point in the first embodiment.

FIG. 8 is a flowchart of a secondary information selection process by a staring point in the first embodiment.

FIG. 9 is a flowchart of a processing of calculating a staring point in primary information in the first embodiment.

FIG. 10 is a diagram for describing an overview of projection conversion in the first embodiment.

FIG. 11 is another diagram illustrating an overview of projection conversion in the first embodiment.

FIG. 12 is a flowchart of a secondary information erasing process in the first embodiment.

FIG. 13 is a diagram for describing an operation overview of selecting secondary information by voice in the first embodiment.

FIG. 14 is a flowchart of a secondary information selection process by voice in the first embodiment.

FIG. 15 is a diagram for describing an operation overview of an HMD cooperative display system in a second embodiment.

FIG. 16 is a diagram illustrating an overview of an HMD cooperative display system in the second embodiment.

FIG. 17 is an overall configuration diagram of the HMD cooperative display system in the second embodiment.

FIG. 18 is a diagram for describing a configuration of a secondary information database in the second embodiment.

FIG. 19 is a diagram for describing a camera image and an in-camera image staring point in the second embodiment.

FIG. 20 is a flowchart of a secondary information selection process by a staring point in the second embodiment.

### MODE FOR CARRYING OUT THE INVENTION

Hereinafter, exemplary embodiments of the present invention will be described with reference to the appended drawings.

### First Embodiment

The present embodiment will be described in connection with an example in which supplement information (secondary information) related to education content (primary information) projected on a screen by a projector is displayed on an HMD worn by a teacher at an education site. According to the present embodiment, the teacher can browse the supplement information related to the education content while conducting a class to students in a natural manner.

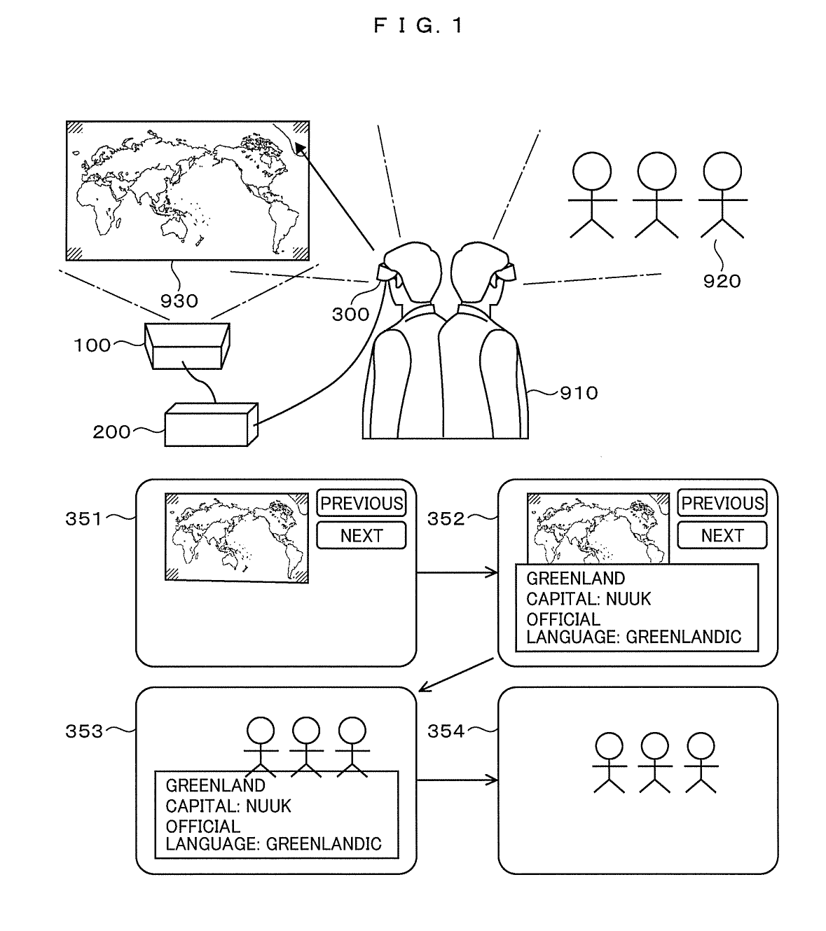

FIG. 1 is a diagram for describing an overview of an operation of an HMD cooperative display system in the present embodiment. In FIG. 1, a projecting apparatus 100 projects education content (a world map in the example,) on a screen 930. A teacher 910 performs a class while alternately viewing students 920 and content projected through an HMD 300. At this time, the scenery seen by the teacher 910 via the HMD 300 at the beginning includes only education content (world map) and buttons (“previous” and “next” in the example) for manipulating display of the content as shown in a screen 351. Then, if the teacher 910 stares at a part near Greenland on the world map, supplement information (a country name, a capital, and an official language in the example) is displayed as shown in a screen 352. Then, if the teacher 910 faces the students 920, the buttons for manipulating the display of the content are erased, and the supplement information continues to be displayed even though the teacher 910 does not look at the world map as shown in a screen 353. Thereafter, if a certain period of time passes, the supplement information is also erased as shown in a screen 354. With such an operation, for example, it is possible to conduct a class without performing an unnatural action of reviewing the direction of the education content one by one and staring at the corresponding part in order to obtain the supplement information.

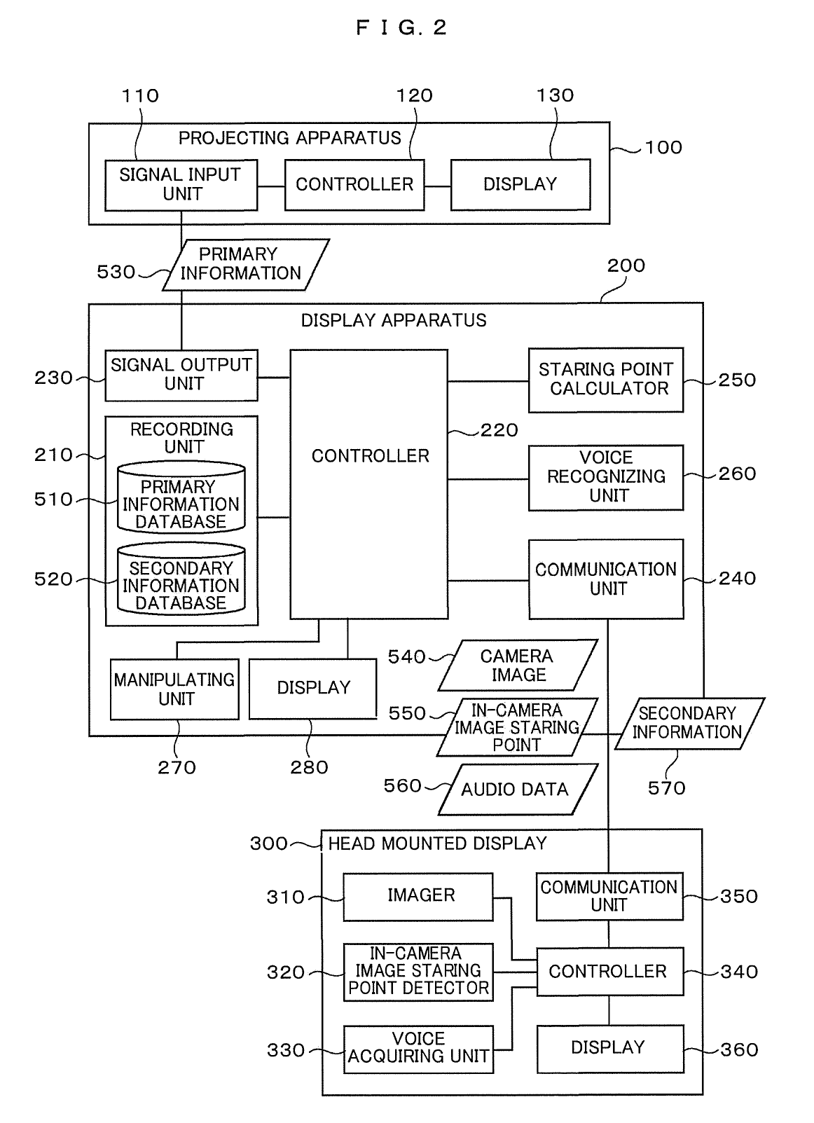

FIG. 2 is an overall configuration diagram of the HMD cooperative display system in the present embodiment. In FIG. 2, the present system includes the projecting apparatus 100, a display apparatus 200, and the HMD 300. The projecting apparatus 100 and the display apparatus 200 are connected by communication, and the display apparatus 200 and the HMD 300 are connected by communication.

The projecting apparatus 100 includes a signal input unit 110 configured to receive primary information to be displayed, a controller 120 configured to control display, and a display 130 configured to project the primary information onto the screen.

The display apparatus 200 includes a recording unit 210 configured to store a primary information database 510 and a secondary information database 520, a controller 220 configured to perform various kinds of processes such as an output of the primary information and the secondary information, a signal output unit 230 configured to output the primary information to the projecting apparatus 100, a communication unit 240 configured to communicate with the HMD 300, a staring point calculator 250 that functions as a staring point detector configured to detect the position of the staring point in the primary information on the basis of the information acquired from the HMD 300 and calculates coordinates serving as position information of the staring point, a voice recognizing unit 260 configured to recognize a voice of an HMD wearer, a manipulating unit 270 configured to manipulate the display apparatus 200, and a display 280. The staring point calculator 250 and the voice recognizing unit 260 may be implemented as dedicated hardware or may be implemented as a software module executed by the controller 220. Further, the staring point calculator 250 may be installed in the HMD 300.

The HMD 300 includes an imager 310 configured to image up a landscape in a direction in which the wearer sees, an in-camera image staring point detector 320 that functions as a line of sight detector configured to detect a line of sight direction of the wearer in the captured camera image, and detects the staring point, a voice acquiring unit 330 configured to acquire a voice of the HMD wearer or the like, a controller 340 configured to perform various kinds of control processes for transmitting an acquired camera image 540, an in-camera image staring point 550, or audio data 560 to the display apparatus 200, a communication unit 350 configured to communicate with the display apparatus 200, and a display 360 configured to display secondary information 570 acquired from the display apparatus as an image which can be browsed or viewed by the wearer.

In the present embodiment, the projecting apparatus 100 corresponds to a projector, and the display apparatus 200 corresponds to a personal computer (PC) connected to the projector, but the present invention is not limited to a configuration using a projector, but the present invention can be applied even when the projecting apparatus 100 is a common display apparatus or when a dedicated apparatus in which the projecting apparatus 100 and the display apparatus 200 are integrated is used. Further, the HMD 300 may be divided into an apparatus which is worn on the head and mainly performs display and an apparatus which is worn on the waist and mainly controls the HMD.

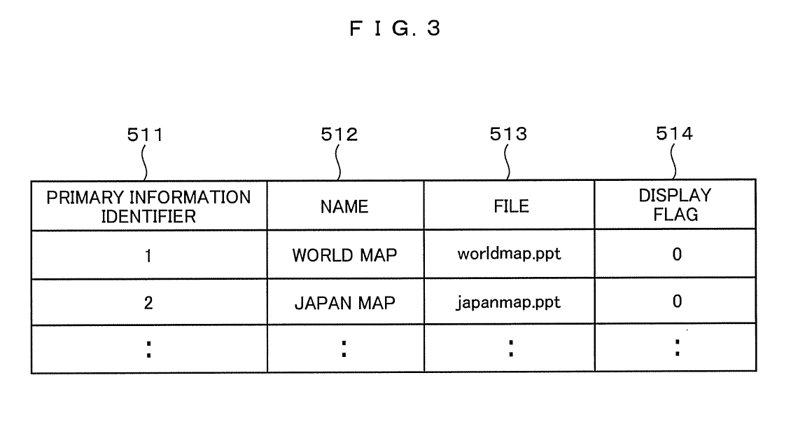

FIG. 3 is a structural diagram of the primary information database 510 in the present embodiment. In FIG. 3, the primary information database 510 includes a primary information identifier 511, a name 512 of the primary information, a name 513 of a file storing the primary information, and a display flag 514 indicating whether or not the primary information is being displayed. The display flag 514 is set to “1” when the primary information is being displayed and “0” when the primary information is not being displayed.

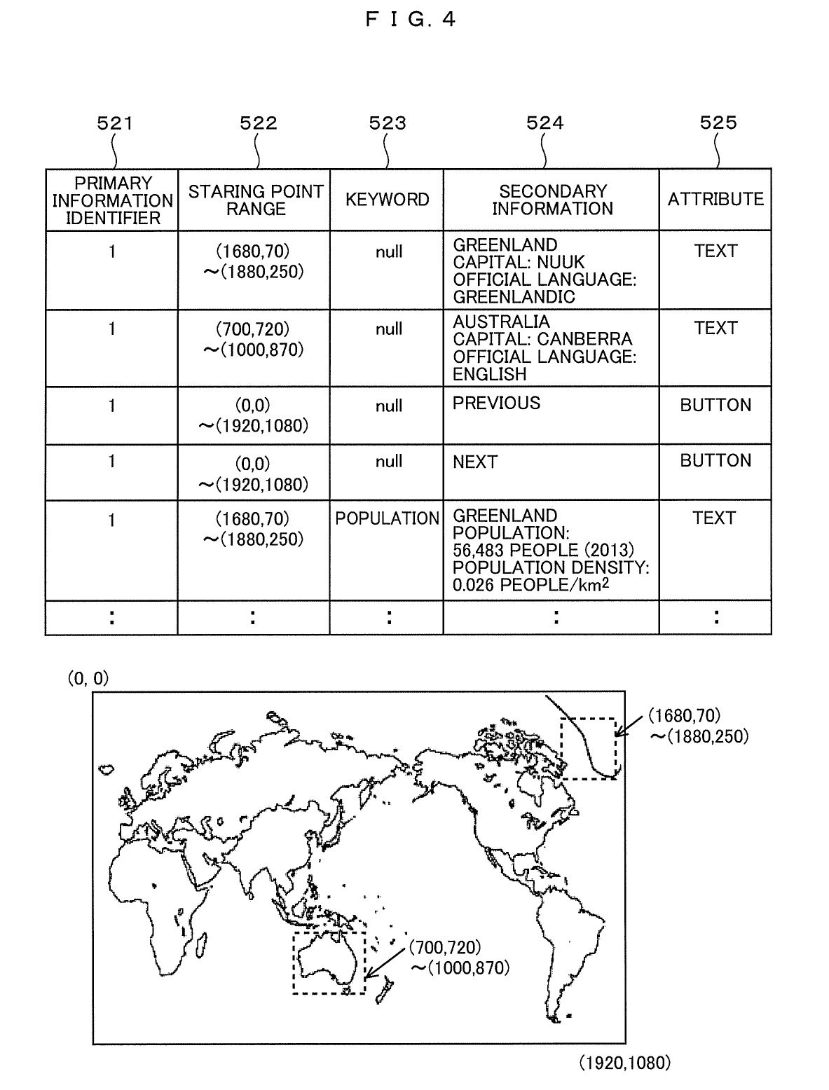

An upper diagram of FIG. 4 is a structural diagram of the secondary information database 520 in the present embodiment. In the upper diagram of FIG. 4, the secondary information database 520 includes a primary information identifier 521 identifying related primary information, a staring point range 522 for selecting the secondary information on the basis of the staring point of the HMD wearer, a keyword 523 for selecting the secondary information on the basis of a voice, secondary information 524, and an attribute 525 of the secondary information. As illustrated by the map illustrated in the lower part of FIG. 4, in the present embodiment, in the coordinate system of primary information, an upper left is defined by (0, 0), a lower right is defined by (1920, 1080), a staring point range (1680, 70) to (1880, 250) of a first line of the secondary information database means coordinates indicating an area near Greenland, and staring point range (700, 720) to (1000, 870) of a second line means coordinates indicating an area near Australia. A staring point range (0, 0) to (1920, 1080) in third and fourth rows of the secondary information database indicate that the secondary information (a “previous” button and a “next” button in the example) are constantly displayed if the staring point is within the range of the primary information.

The configuration of the HMD cooperative display system of the present embodiment has been described above. The present embodiment will be described below with reference to the flow of the operation of the present system.

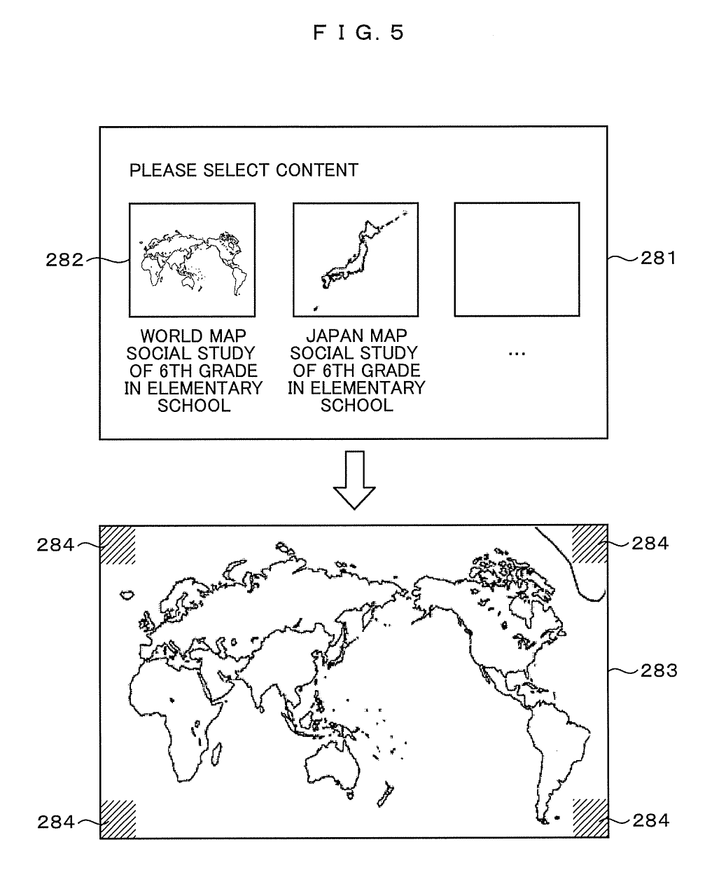

FIG. 5 is a diagram for describing a manipulation of selecting the education content (primary information) projected on the screen 930 displayed on the display apparatus display 280 in the present embodiment. In FIG. 5, a screen 281 is an education content selection screen and displays a plurality of icons including an icon 282 for displaying a world map. Here, when the icon 282 is selected, a world map 283 is displayed as illustrated in a lower part of FIG. 5. In the world map 283, markers 284 indicated by hatching are displayed at the four corners. This is identification information identifying a display region of the primary information, and the details thereof will be described later.

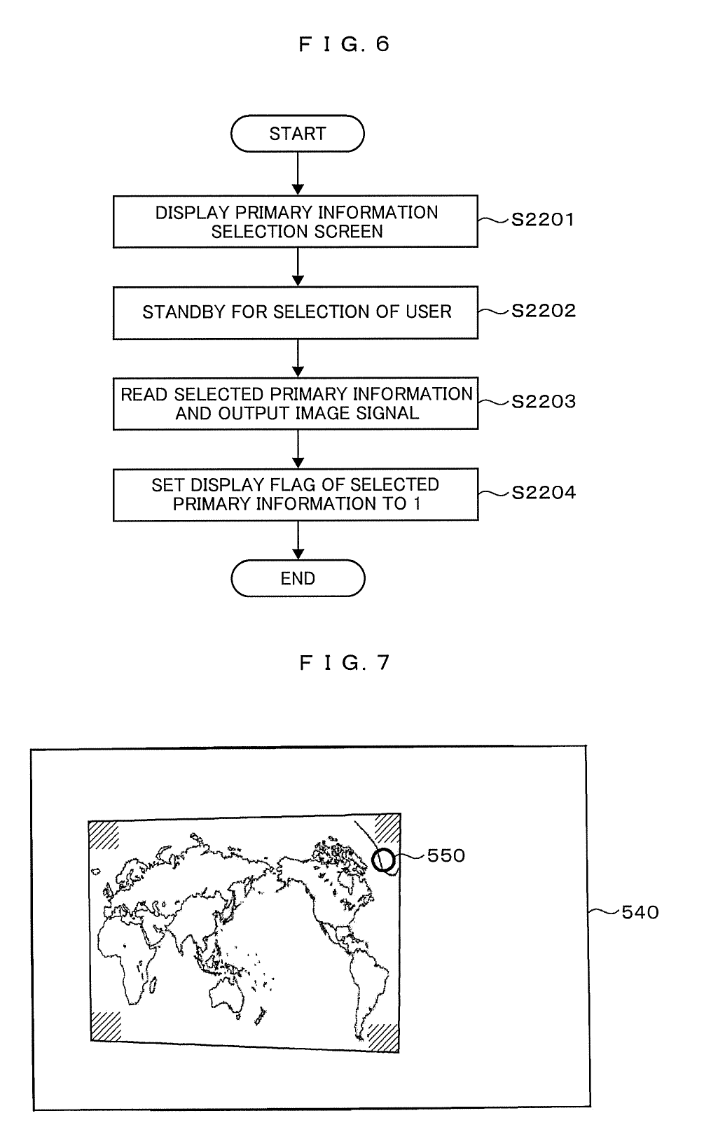

FIG. 6 is a flowchart of a process of the controller 220 when the primary information is selected in the present embodiment. In FIG. 6, the controller 220 reads a list of primary information from the primary information database 510 and displays the list on the selection screen 281 including an icon indicating each piece of content (step S2201). Then, in step S2202, it is on standby until the user selects content. Then, a file 513 corresponding to the primary information selected by the user is read and projected onto the screen 930 via the signal output unit 230 and the projecting apparatus 100 (step S2203). Finally, the display flag 514 of the selected primary information is set to 1, and the process ends (step S2204).

FIG. 7 is a diagram illustrating the camera image 540 and the in-camera image staring point 550 acquired by the imager 310 of the HMD 300 and the in-camera image staring point detector 320 when the teacher 910 browses the screen 930 onto which the education content is projected in step S2203 of FIG. 6 via the HMD 300. FIG. 7 illustrates an example in which the teacher 910 is browsing the primary information from a position on a slightly right side toward the screen 930 and staring at a part near Greenland.

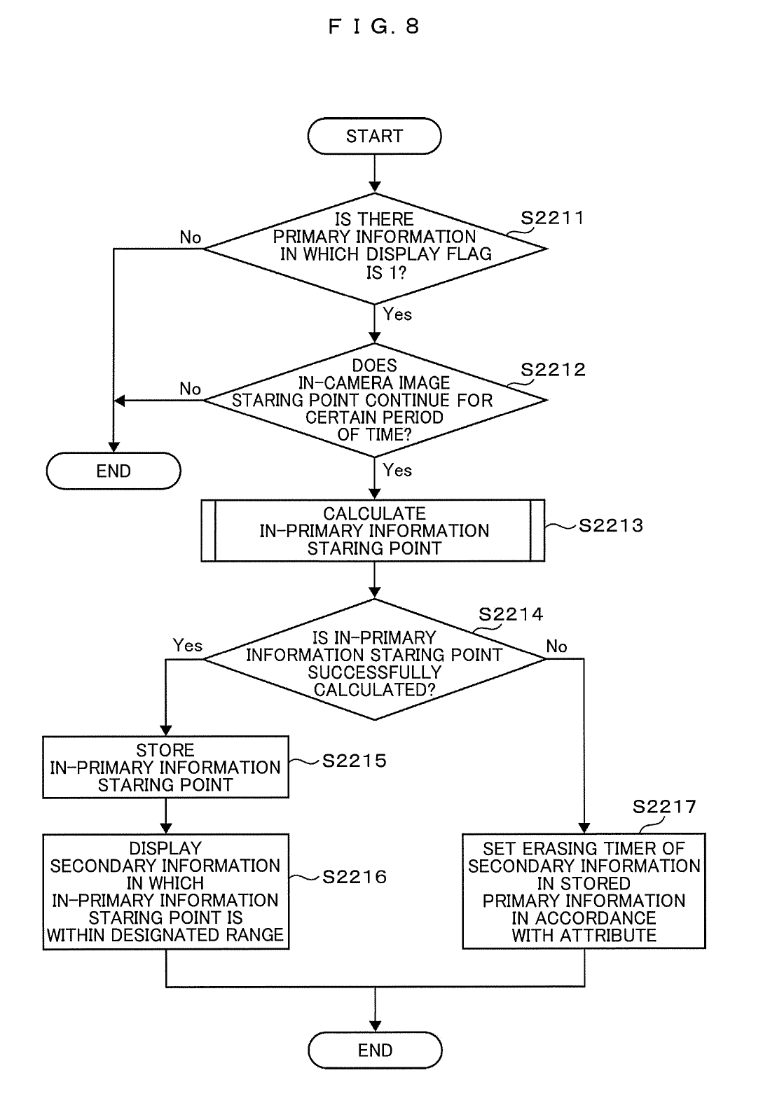

FIG. 8 is a flowchart of a process of selecting the secondary information which is executed in the controller 220 of the display apparatus 200 when the camera image 540 and the in-camera image staring point 550 illustrated in FIG. 7 are received from the HMD 300 in the present embodiment. In FIG. 8, first, the controller 220 determines whether or not there is primary information in which the display flag is set to 1 with reference to the primary information database 510 (step S2211). With the manipulation illustrated in FIG. 5, the display flag of the first line (world map) of the primary information database 510 is set to 1. Then, it is determined whether or not the in-camera image staring point 550 continues for a certain period of time, that is, whether or not the staring point of the teacher 910 is staying at a specific position (step S2212). This determination can be implemented, for example, by a process of determining whether or not a state in which a distance difference with a previously received in-camera image staring point is less than a predetermined threshold value continues for a certain period of time. Then, the staring point in the primary information is calculated using the staring point calculator 250 (step S2213). This processing will be described later in detail.

Then, it is determined whether or not the staring point in the primary information is successfully calculated (step S2214). In a case in which the staring point in the primary information is successfully calculated, that is, in a case in which the staring point of the teacher 910 is in the direction of the primary information (that is, the direction of the screen 930), the staring point in the primary information calculated in step S2213 is stored (step S2215). Then, secondary information in which the staring point in the primary information stored in step S2213 is within the range of the staring point range 522 of the secondary information database 520 among the secondary information related to the primary information being displayed is displayed with reference to the secondary information database 520 (step S2216). On the other hand, in a case the staring point in the primary information fails to be calculated in step S2214, that is, in a case in which the staring point is outside the marker range of the primary information, an erasing timer is set in the secondary information corresponding to the staring point in the primary information stored in step S2215 (that is, the secondary information being currently displayed) in accordance with the attribute 525 of the secondary information (step S2217). The erasing timer refers to a period of time until the secondary information displayed on the HMD 300 is erased, and for example, a setting is performed such that in a case in which the attribute 525 of the secondary information is a text, the secondary information is erased after 60 seconds, and in a case in which the attribute 525 of the secondary information is a button, the secondary information is erased after 0 seconds (that is, immediately). Accordingly, when the teacher 910 faces in the direction of the students 920, an operation in which the button is immediately erased, but the text is continuously displayed for a certain period of time is performed. Further, in a case in which the staring point in the primary information fails to be calculated at the beginning of the present secondary information selection flow, since there is no stored staring point in the primary information, the erasing timer is not set. As described above, when the position information of the staring point of the wearer is determined to be in the primary information, the display method of whether the secondary information is continuously displayed or immediately erased is changed to be different from that when the position information of the staring point of the wearer is determined not to be in the primary information. In other words, the display layout or the display menu may be changed.

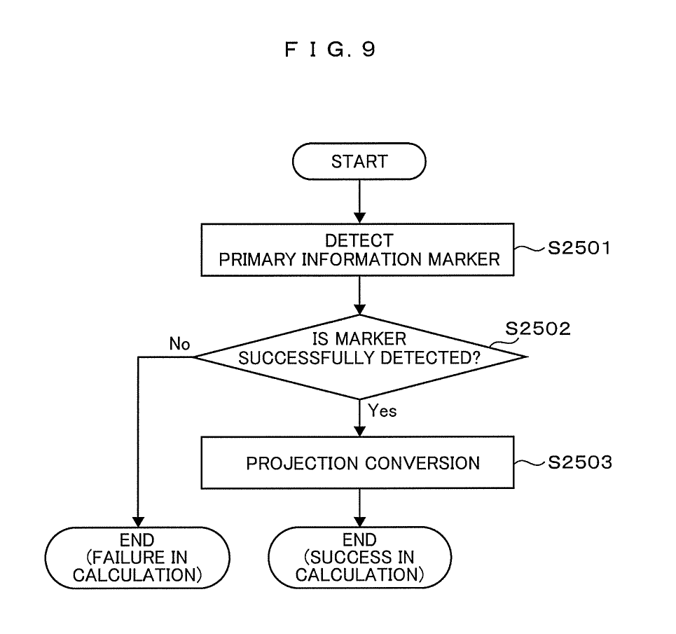

FIG. 9 is a flowchart illustrating a process of calculating the staring point in the primary information using the staring point calculator 250 which is executed in step S2213. The staring point calculator 250 first detects the markers 284 assigned to the four corners of the primary information (step S2501). Then, it is determined whether or not the marker is detected (step S2502). In a case in which the markers are not detected, the process ends since the calculation has failed, whereas in a case in which the markers are detected, the coordinates of the staring point in the primary information are calculated through projection conversion to be described later (step S2503), and the process ends.

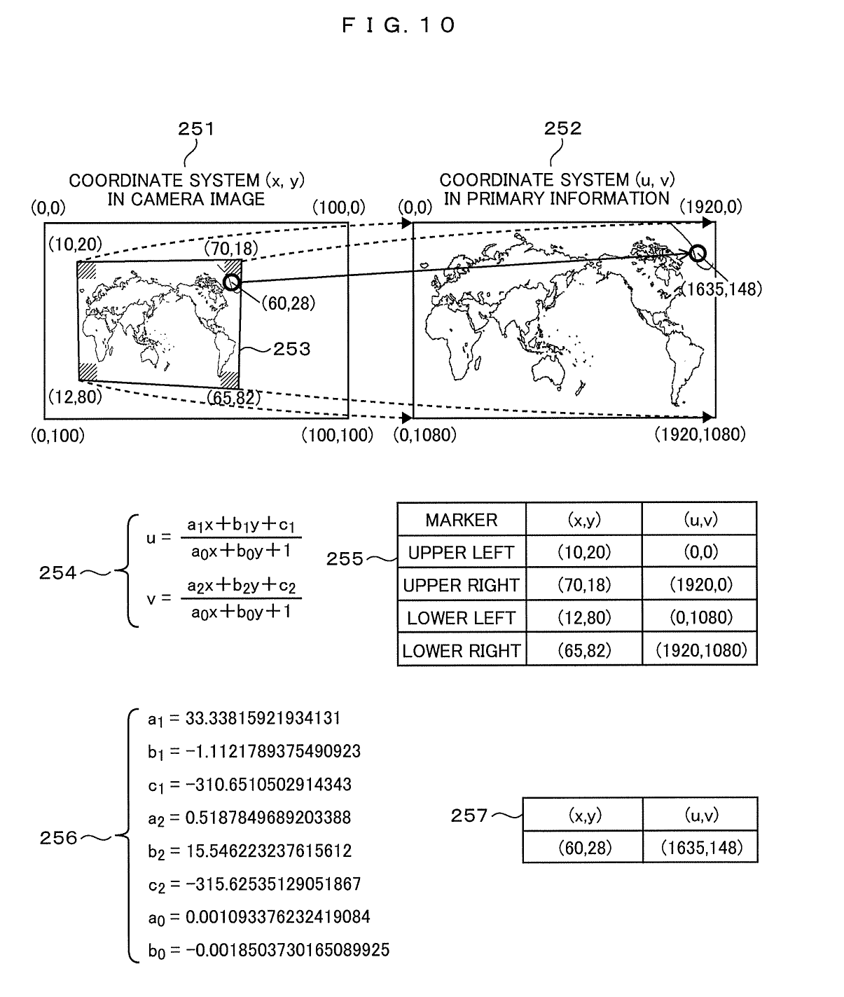

FIG. 10 is a diagram for describing an overview of the projection conversion executed in step S2503. With the calculation described below, coordinating of the staring point in a coordinate system 251 in the camera image can be converted into coordinates in a coordinate system 252 in the primary information.

In FIG. 10, the coordinate system 251 in the camera image is assumed to be a plane in which an upper left is (0, 0), and a lower right is (100, 100). On the other hand, the coordinate system 252 in the primary information is assumed to be a plane in which an upper left is (0, 0), and a lower right is (1920, 1080). Here, a region 253 of the primary information in the camera image specified by the markers at the four corners detected at step S2501 is converted into a region of the coordinate system in the primary information. There are various calculation formulas as the calculation formula of the conversion, but in the present embodiment, a common projection conversion formula 254 is used. Here, (x, y) is coordinates before the conversion (in the coordinate system 251 in the camera image), and (u, v) is coordinates after the conversion (in the coordinate system 252 in the primary information). The projection conversion formula 254 has eight unknowns (a1, b1, c1, a2, b2, c2, a0, and b0). Therefore, unknowns can be derived by substituting four points whose corresponding coordinates are known in both the coordinate systems and obtaining eight equations. A correspondence table 255 of the coordinates indicates the correspondence between the coordinates (x, y) of the four markers detected in step S2501 of FIG. 9 and the coordinates (u, v) after the conversion. Coordinates (10, 20) on the upper left correspond to (0, 0), coordinates on the upper right (70, 18) correspond to (1920, 0), coordinates on the lower left correspond to (0, 1080), and coordinates (65, 82) on the lower right correspond to (1920, 1080). If these values are substituted into the projection conversion formula 254, a simultaneous equation including eight equations is obtained, and if the simultaneous equation is solved, a calculation result 256 of the unknowns is obtained. A coordinate conversion result 257 of the staring point indicates that (60, 28) is converted into (1635, 148) if a calculation is performed in accordance with the projection conversion formula 254 using the calculation result 256 of the unknowns (here, the calculation result is rounded to an integer). With the above calculation, the staring point in the coordinate system in the camera image is converted into the coordinates in the coordinate system in the primary information.

In the present embodiment, it is assumed that the markers having the hatched pattern are displayed at the four corners of the primary information, and the region of the primary information is detected by the image recognition on the markers as in the examples illustrated in FIGS. 5 and 7, but various techniques can be used as the markers. For example, a pattern other than hatching may be used, or a method of embedding a physical device for region detection on the screen 930 side instead of displaying the markers may be used. Further, instead of a visible pattern visible to humans, an invisible marker using an infrared camera or the like may be used.

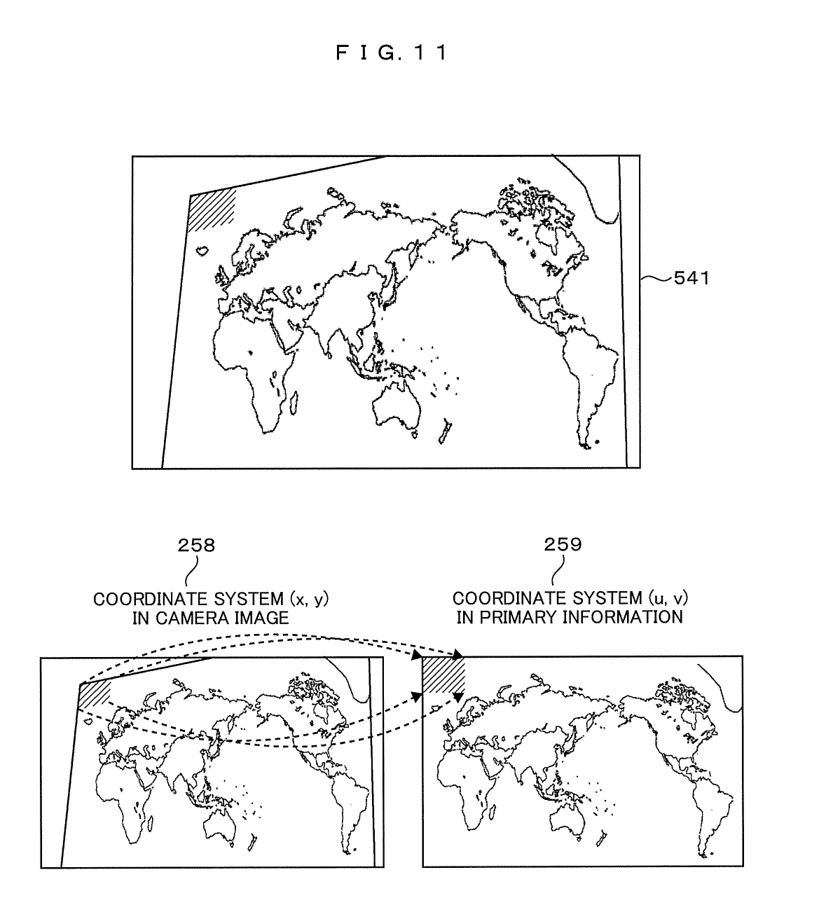

Further, in FIG. 10, the example in which the projection conversion is performed using the coordinates of the four corners of the region of the primary information has been described, but the method of the projection conversion is not limited to this example. For example, FIG. 11 is a conceptual diagram illustrating another method of the projection conversion. If the HMD wearer comes to a position close to the screen 930 when browsing the primary information, the markers at the four corners may not be included in the camera image as in a camera image 541 illustrated in FIG. 11. In this, it is possible to perform coordinates conversion of the staring point by obtaining the unknowns of the formula 254 of the projection conversion on the basis of the coordinates of the four corners in one marker instead of using the correspondence of the coordinates of the four corners of the region of the primary information in a coordinate system 258 in the camera image and a coordinate system 259 in the primary information. In addition, it is possible to derive the unknowns of the projection conversion on the basis of four points by performing image recognition on both the camera image and the primary information and extracting four points having a feature (feature points) dynamically instead of using coordinates of predetermined four points. Such a technique is widely used, for example, in a process or the like in a case in which a human face is recognized from various angles.

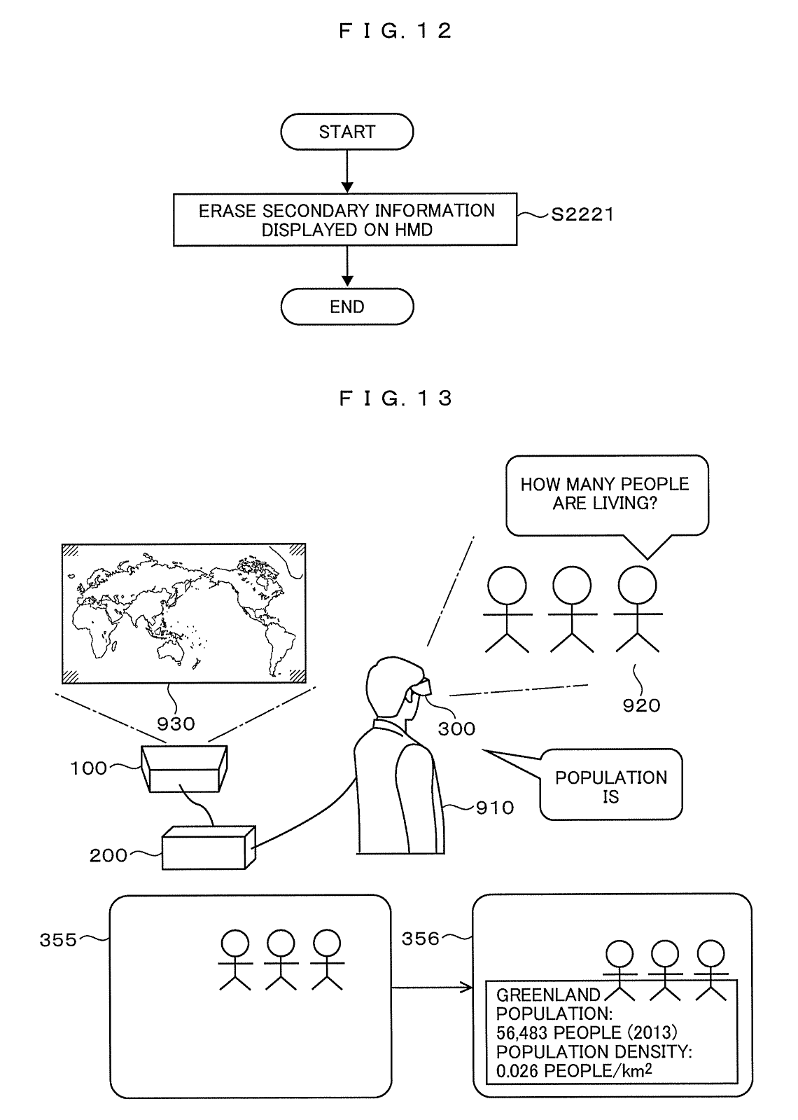

Finally, FIG. 12 is a flowchart illustrating a process of erasing the secondary information which is activated when the erasing timer set in step S2217 of FIG. 8 reaches a predetermined time. In FIG. 12, when the erasing timer reaches a predetermined time, the controller 220 erases the secondary information displayed on the HMD (step S2221). Since the value of the erasing timer is changed in accordance with the attribute of the secondary information as described above, when the teacher looks away from the screen 930 and then looks at the students 920, the operation in which the buttons are immediately erased, but the text (supplement information) is continuously displayed can be performed.

With the above-described content, the operation illustrated in FIG. 1 can be performed. In other words, a scenery when the teacher 910 faces in the direction of the screen 930 via the HMD 300 is initially the screen 351 in FIG. 1. Then, if the teacher 910 looks at an area near Greenland on the world map, the screen 352 in FIG. 1 is displayed by the process of up to step S2216 in FIG. 8. Then, when the teacher 910 faces in the direction of the students 920, the screen 353 of FIG. 1 is displayed until the time of the erasing timer set in step S2217 of FIG. 8 elapses, and the text (supplement information) is continuously displayed. When the time of the erasing timer set in the text elapses, the screen 354 of FIG. 1 is displayed.

In addition to the setting of the erasing timer in step S2217 of FIG. 8, the transmittance of the secondary information displayed in the HMD may be changed in accordance with the attribute 525 of the secondary information. For example, when the teacher 910 faces in the direction of the screen 930, the transmittance of the supplement information becomes 0%, that is, the supplement information is displayed with no transmittance as shown in the screen 352 of FIG. 1, but when the teacher 910 faces in the direction of the students 920, the transmittance of the supplement information may become 50%, that is, the supplement information may be displayed with transmittance of 50% as shown in the screen 353 of FIG. 1. Accordingly, it is possible to prevent the state of the students 920 from becoming invisible since the supplement information is displayed.

Then, as another operation of the present embodiment, an example of an operation of displaying the secondary information by voice even when the primary information is not viewed will be described.

FIG. 13 is a diagram for describing an overview of an operation of displaying the secondary information by voice in the present embodiment. FIG. 13 illustrates an example in which subsequently to the operation described until now, the teacher 910 faces in the direction of the students 920, the students 920 ask a question “How many people are living,” and the teacher 910 says “population is . . . .” At this time, as the scenery seen by the teacher 910 via the HMD 300, only students are initially visible as shown in the screen 355, and then when “population is . . . ” is sad, the supplement information (a country name, a population, and a population density in the example) is displayed. The speech may cause the supplement information to be displayed in response to the voice from the students. At that time, the speech may be recognized, the keyword may be displayed, and when the keyword is stared at, the supplement information may be displayed.

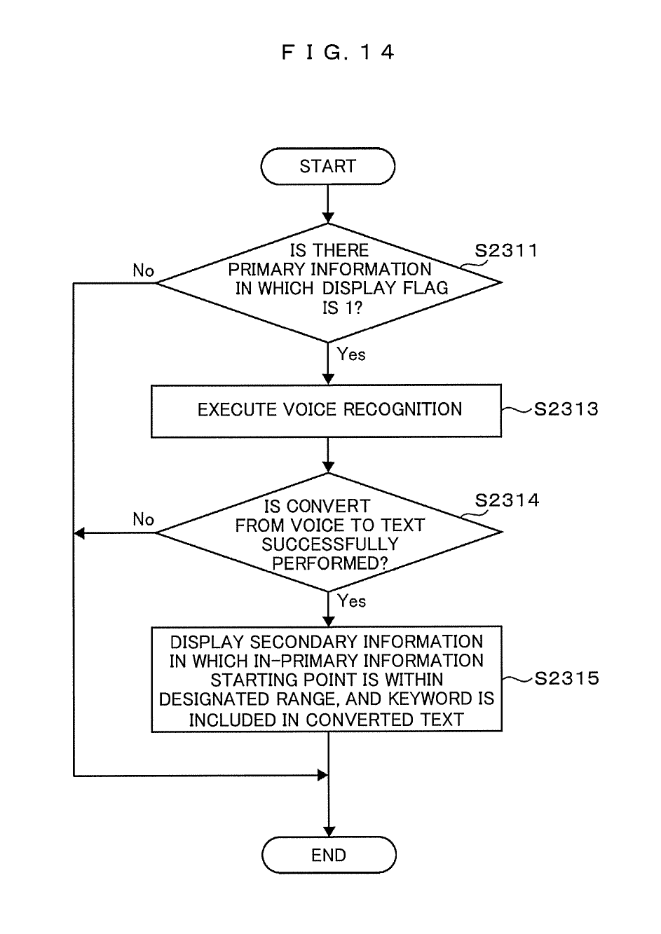

FIG. 14 is a flowchart of a process for selecting the secondary information which is executed when a speech of the teacher 910 is acquired through the voice acquiring unit of the HMD 300 in the present embodiment, and the controller 220 of the display apparatus 200 receives the audio data 560. In FIG. 14, similarly to FIG. 8, the controller 220 first determines whether or not there is primary information in which the display flag is set to 1 with reference to the primary information database 510 (step S2311). Then, the voice recognition process is executed on the received audio data 560 (step S2313). The voice recognition process is not limited to the method executed in the display apparatus 200 but may be executed by means of communication performed with a server configured to perform voice recognition via the Internet or the like. Further, the voice recognition process may be constantly triggered with a predetermined period or may be triggered when a predetermined button is pushed. Then, it is determined whether or not the conversion process from the audio data 560 to the text by voice recognition is successfully performed (step S2314). This determination may be performed simply on the basis of whether or not the voice recognition is executable or may be determined on the basis of reliability of a conversion result output by a common voice recognition technique. Further, a speaker may be identified using a technique such as voiceprint analysis in combination, and the success may be determined only for the speech of the teacher 910 while ignoring the speech of the students 920. Then, when the conversion from the voice to the text is successfully performed, the secondary information in which the staring point in the primary information stored in step S2215 of FIG. 8 is within the range of the staring point range 522 in the secondary information database, and a word indicated in the keyword 523 of the secondary information database 520 is included in the converted text among the secondary information related to the primary information currently being displayed is displayed with reference to the secondary information database 520 (step S2315). In the example of the secondary information database illustrated in FIG. 4, the secondary information of the fifth line in which “population” is set in the keyword is displayed.

Further, here, the example in which the secondary information is displayed immediately when a specific keyword is included in the speech content has been described, but instead of immediately displaying the secondary information after the voice is recognized, a button indicating the recognized keyword may be displayed on the HMD, and the secondary information may be displayed when the button is selected. Further, even when the speech content does not completely coincide with the keyword, similarity of character strings may be determined, and the secondary information may be displayed when the speech content is similar to the keyword.

With the above process, the operation illustrated in FIG. 13 can be performed. In other words, the scenery when the teacher 910 faces in the direction of the students 920 via the HMD 300 is initially the screen 355 of FIG. 1. Then, when the teacher 910 speaks “population is . . . ,” the screen 356 of FIG. 1 is displayed by the process of up to step S2315 of FIG. 14.

As described above, in the present embodiment, the position information of the staring point of the wearer in the primary information is calculated on the basis of the camera image acquired from the HMD and the staring point of the wearer of the HMD in the camera image, and the secondary information related to the position information is selected and displayed, and when the wearer of the HMD is viewing the primary information, the display method of the secondary information displayed on the HMD is changed to be different from that when the wearer is not viewing the primary information. Accordingly, the teacher can obtain the supplement information of the education content projected on the screen while conducting a class to the students in a natural manner.

In other words, the present embodiment provides a system including a display apparatus and a head mounted display, wherein the display apparatus includes a first display that is capable of displaying an image or a projecting unit that is capable of projecting an image, and a first communication unit that is capable of performing communication with the head mounted display, the head mounted display includes a second display configured to display an image which is viewed by a wearer of the head mounted display, a line of sight detector configured to detect a line of sight direction of the wearer of the head mounted display, and a second communication unit that is capable of performing communication with the display apparatus, a staring point detector configured to detect a position of a staring point of a line of sight of the wearer of the head mounted display with respect to the image displayed by the first display of the display apparatus or the image projected by the projecting unit on the basis of information transmitted and received via the first communication unit and the second communication unit is installed in either of the display apparatus and the head mounted display, the staring point detector calculates position information in the image corresponding to the position of the staring point when the staring point is on the image, and the head mounted display acquires relevant data related to target data displayed at the calculated position in the image by means of the communication with the display apparatus or other communication and displays the relevant data on the second display.

Further, provided is a head mounted display cooperative display system including a display apparatus and a head mounted display, the display apparatus includes a first display configured to display primary information, a projecting unit configured to project the primary information, or a signal output unit configured to output an image signal, a first communication unit that is capable of performing communication with the head mounted display, and a staring point calculator configured to calculate position information of a staring point of a wearer of the head mounted display with respect to the primary information, the head mounted display includes a second display configured to display secondary information which is viewed by the wearer, a second communication unit that is capable of performing communication with the display apparatus, an imager configured to capture a camera image in a direction in which the wearer faces, and an in-camera image staring point detector configured to detect a staring point of the wearer with respect to the camera image, and the display apparatus calculates position information of a staring point of the wearer with respect to the primary information by the staring point calculator on the basis of the detected staring point transmitted and received via the first communication unit and the second communication unit, selects the secondary information related to the position information, and changes a display method of the secondary information in the second display when the position information is determined to be in the primary information to be different from a display method when the position information is determined not to be in the primary information.

Accordingly, since the appropriate secondary information can be selected and displayed regardless of the position or the direction of the line of sight of the wearer of the HMD, there is an effect in that it is possible to increase the degree of freedom of the behavior of the wearer of the HMD and browse the secondary information in a more natural manner.

### Second Embodiment

The present embodiment will be described in connection with an example in which supplement information (secondary information) related to broadcast information (primary information) displayed on a television is displayed on an HMD worn by a television viewer in general home or the like. According to the present embodiment, it is possible to obtain the supplement information which is unable to be obtained only from broadcast content when a television is viewed and to browse the secondary information even when the viewer look away from the television.

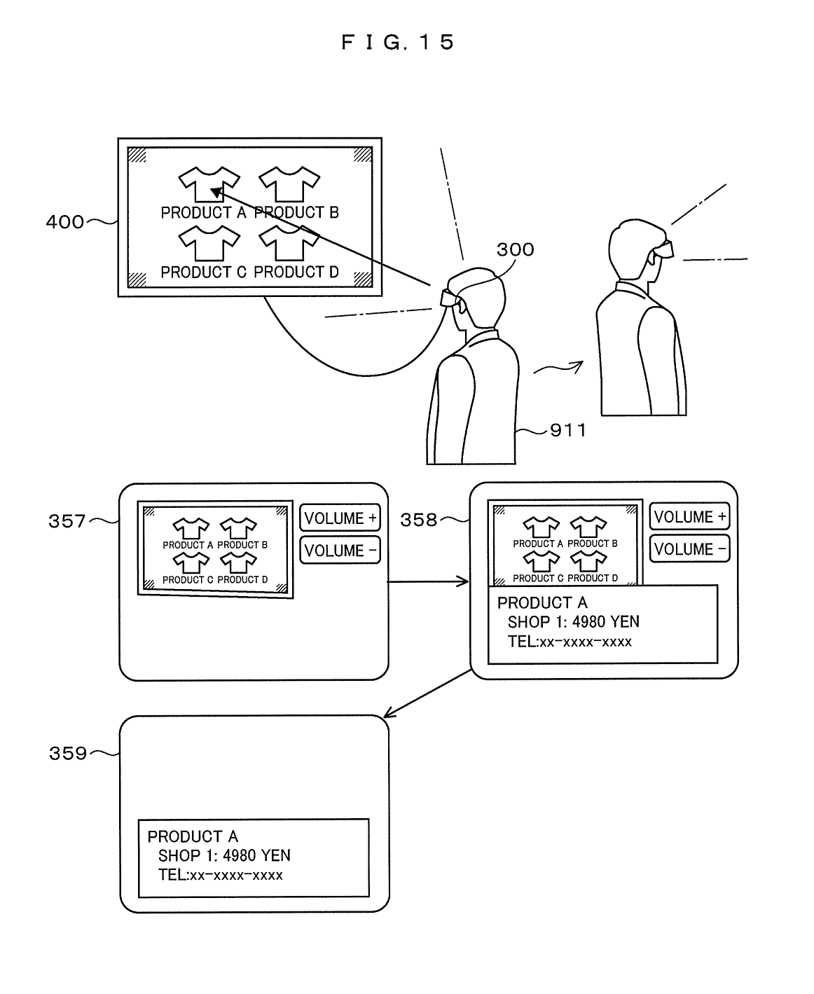

FIG. 15 is a diagram for describing an overview of an operation of an HMD cooperative display system in the present embodiment. In FIG. 15, a display apparatus 400 displays content of a television broadcast on a screen. The screen illustrated in FIG. 15 shows a state in which a program of offering information of four products, that is, a product A, a product B, a product C, and a product D as content of a television broadcast. A viewer 911 is viewing the displayed screen via the HMD 300. At this time, as the scenery seen by the viewer 911 via the HMD 300, a television screen and buttons for manipulating the television (for example, a button “volume+” and a button “volume −” for adjusting the volume of the television are illustrated) are initially seen as shown in a screen 357. Then, if the viewer 911 stares at the product A displayed on the television screen, supplement information (a shop selling the product A, a price, and a telephone number, in example) is displayed as shown in a screen 358. Then, if the viewer 911 looks away from the television screen, the buttons for manipulating the television are erased, and the supplement information is continuously be displayed even when the viewer 911 does not view the television screen as shown in a screen 359. With the operation described above, it is possible to check the supplement information in a case in which the viewer 911 is apart from the television, for example, in order to make a phone call to a shop displayed in the supplement information.

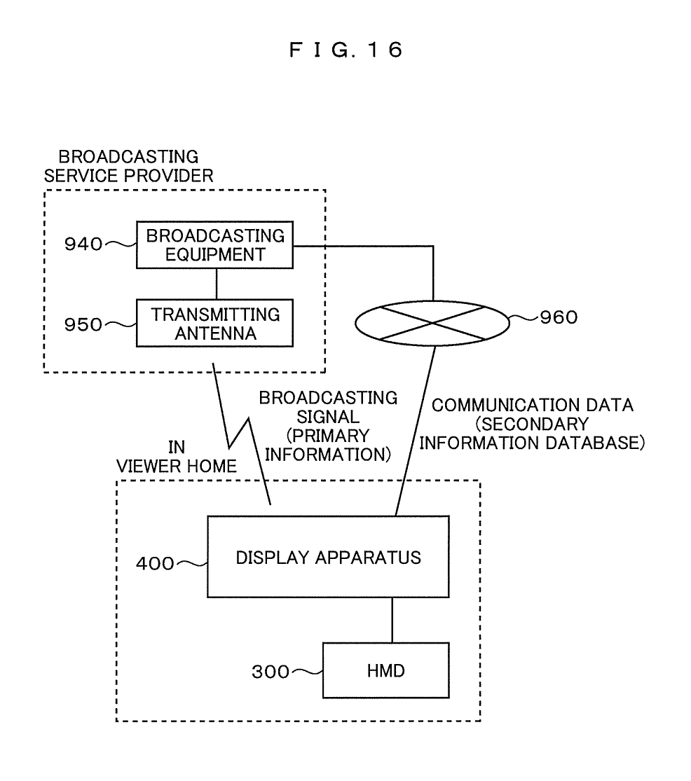

FIG. 16 is a diagram for describing an overall image of the HMD cooperative display system in the present embodiment. In FIG. 16, the present system includes a broadcasting equipment 940 configured to transmit a broadcast signal via a transmitting antenna 950, a display apparatus 400 configured to receive and displays the broadcast signal, and an HMD 300. The display apparatus 400 can receive communication data via a communication network 960 such as the Internet in addition to the usual broadcast signal. Further, as an apparatus configured to receive and display both the broadcast signal and the communication data, for example, there is a television or the like compatible with a hybrid cast (registered trademark). In the present embodiment, by using such an apparatus, a secondary information database related to a television broadcast (primary information) received through the broadcast signal is acquired by means of communication via the Internet.

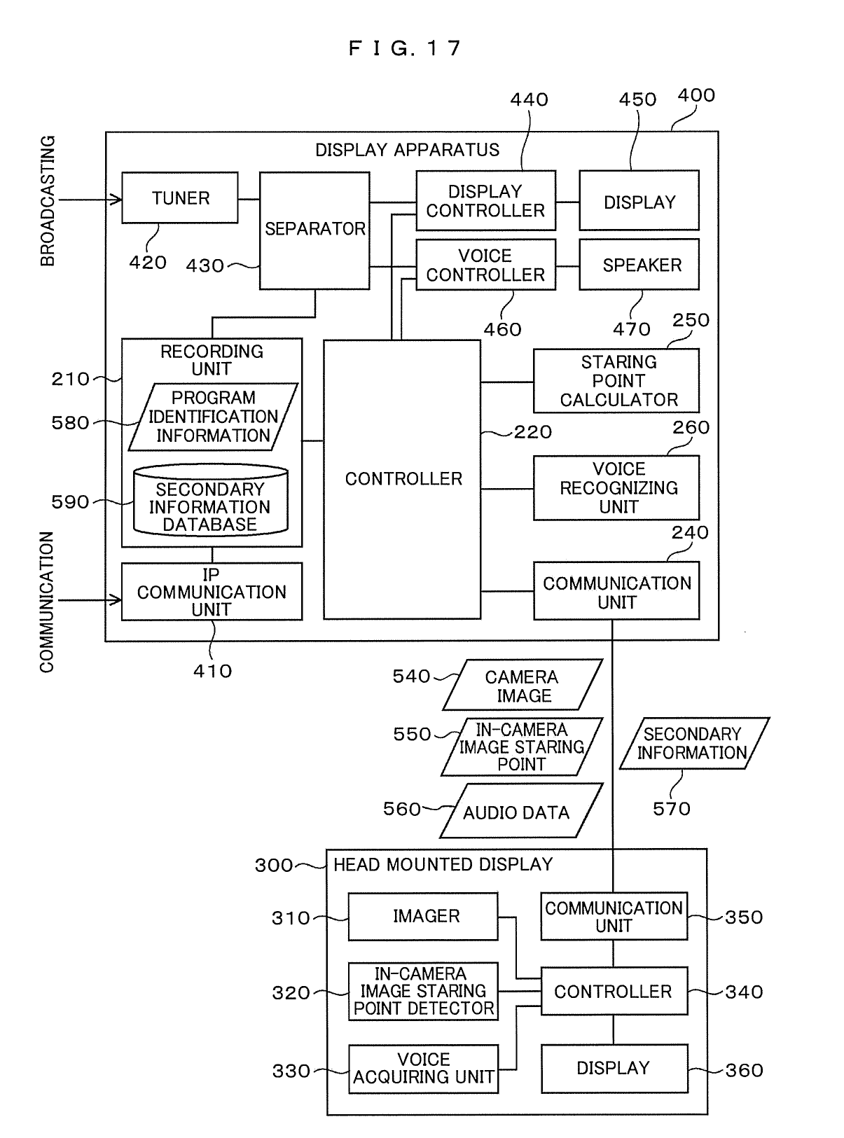

FIG. 17 is an overall configuration diagram of the HMD cooperative display system in the present embodiment. In FIG. 17, the display apparatus 400 of the present embodiment has a configuration in which several modules including an apparatus such as a television through which it is possible to view both the broadcast signal and the communication data are added to the display apparatus 200 described in the first embodiment. The display apparatus 400 includes a tuner 420 configured to receive a broadcast signal, a separator 430 configured to separate the received broadcast signal into various kinds of signals such as a video, an audio, and data and outputs them, a display controller 440 configured to perform a process such as demodulation of the received video signal, a voice controller 460 configured to perform a process such as demodulation of the received voice signal, and a speaker 470 configured to output a voice. These modules are modules necessary in common televisions for the viewer to watch the broadcast signal. In addition to these modules, the display apparatus 400 includes an Internet protocol (IP) communication unit 410 configured to receive communication data via a communication network such as the Internet, a recording unit 210 configured to store program identification information 580 storing a channel number currently being viewed or the like and a secondary information database 590, a controller 220 configured to perform various kinds of processes such as an output of the primary information and the secondary information, a communication unit 240 configured to perform communication with the HMD 300, a staring point calculator 250 configured to calculate coordinates of the staring point in the primary information on the basis of the information acquired from the HMD 300, and a voice recognizing unit 260 configured to recognize a speech of the HMD wearer or the like. The staring point calculator 250 and the voice recognizing unit 260 may be implemented as dedicated hardware or may be implemented as a software module executed by the controller 220. The configuration of the HMD 300 is similar to that of the first embodiment.

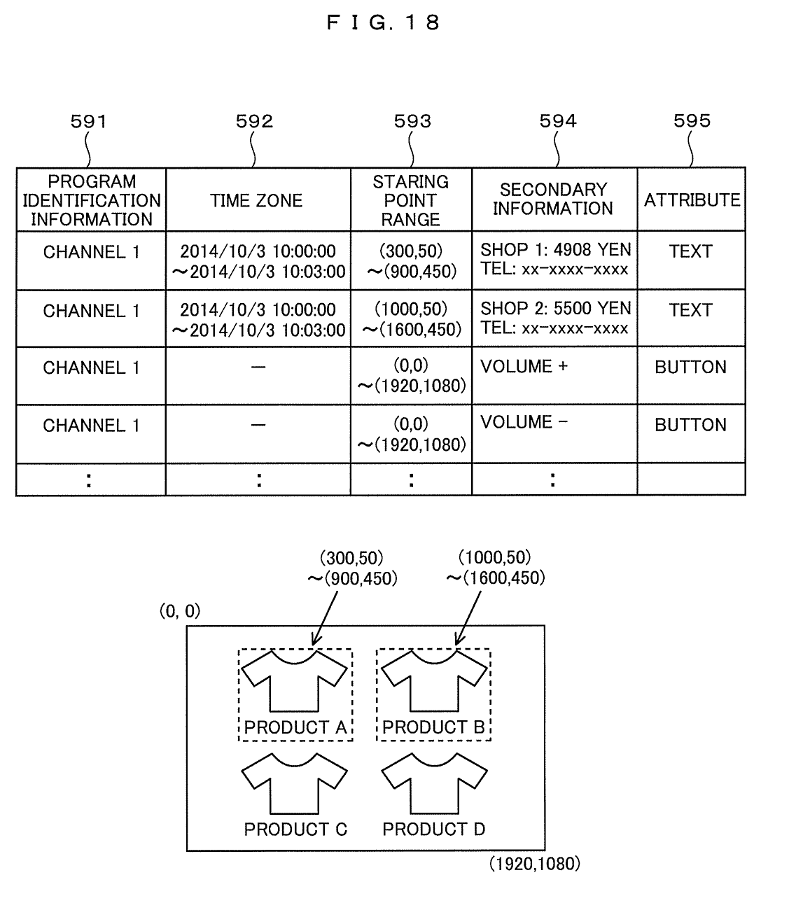

FIG. 18 is a diagram for describing a configuration of the secondary information database 590 in the present embodiment. In FIG. 18, the secondary information database 590 includes program identification information 591, a time zone 592 indicating a period in which the secondary information is valid, a staring point range 593 for selecting the secondary information on the basis of the staring point of HMD wearer, secondary information 594, and an attribute 595 of the secondary information. As shown in a screen in a lower part of FIG. 18, in the present embodiment, in the coordinate system of the primary information, an upper left is defined by (0, 0), a lower right is defined by (1920, 1080), a staring point range (300, 50) to (900, 450) of a first line of the secondary information database means coordinates indicating a rectangular range including an image of the product A, and a staring point range (1000, 50) to (1600, 450) of a second line means coordinates indicating a rectangular range of an image of the product B.

The configuration of the HMD cooperative display system of the present embodiment has been described above. The present embodiment will be described according to the flow of the operation of the present system. A manipulation of manipulating the display apparatus 400 and watching the television broadcast is similar to a method of manipulating a television which is commonly used, and thus description thereof is omitted. In the following description, a channel 1 is assumed to be viewed.

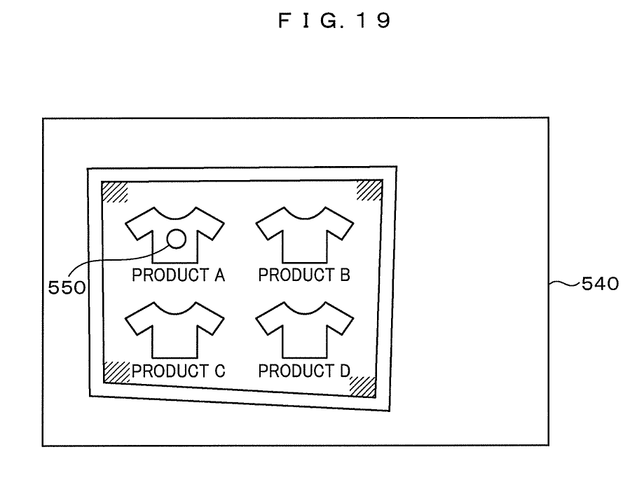

FIG. 19 illustrates the camera image 540 and the in-camera image staring point 550 acquired by the imager 310 and the in-camera image staring point detector 320 of the HMD 300 when the viewer 911 faces in the direction of the display apparatus 400 via the HMD 300. FIG. 19 illustrates a state in which the viewer 911 is browsing the primary information from a position on a slight right side toward the display apparatus 400 and staring at the product A.

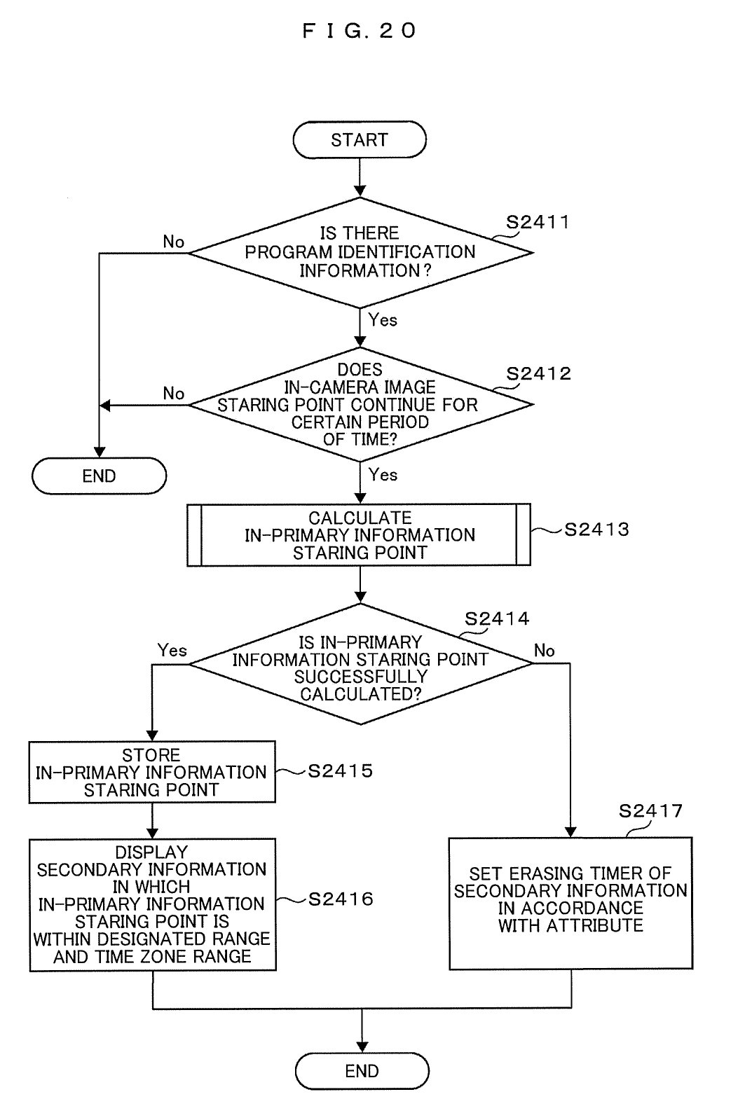

FIG. 20 is a flowchart of a process of selecting the secondary information which is executed in the controller 220 of the display apparatus 400 when the camera image 540 and the in-camera image staring point 550 are received from the HMD 300 in the present embodiment. In FIG. 20, first, the controller 220 determines whether or not the program identification information 580 is recorded in the recording unit 210 (step S2411). Since the channel 1 is currently being viewed, there is program identification information 580, and the channel 1 is described as a program being viewed. Then, it is determined whether or not the in-camera image staring point 550 continues for a certain period of time, that is, whether or not the staring point of the viewer 911 is staying at a specific position (step S2412). Then, the staring point in the primary information is calculated using the staring point calculator 250 (step S2413). The detailed process is similar to that described with reference to FIGS. 9 to 11 of the first embodiment.

Then, it is determined whether or not the staring point in the primary information is successfully calculated (step S2414). In a case in which the staring point in the primary information is successfully calculated, that is, that is, in a case in which the staring point of the viewer 911 is in the direction of the primary information (that is, in the direction of the display apparatus 400), the staring point in the primary information calculated in step S2413 is stored (S2415). Then, secondary information in which the stored staring point in the primary information is within the range of the staring point range 593 of the secondary information database 520, and a current time is within a range of the time zone 592 of the secondary information database among the secondary information related to the program currently being viewed is displayed with reference to the secondary information database 590 (step S2416).

On the other hand, in a case in which the staring point in the primary information fails to be calculated in step S2414, an erasing timer is set in the secondary information corresponding to the staring point in the primary information stored in step S2415 (that is, the secondary information being currently displayed) in accordance with the attribute 595 of the secondary information (step S2417). For example, in a case in which the attribute 595 of the secondary information is a text, a setting is performed such that the secondary information is erased after 60 seconds, and in a case in which the attribute 595 of the secondary information is a button, the secondary information is erased after 0 seconds (that is, immediately). Thus, when the viewer 911 looks away from the display apparatus 400, an operation in which the button is immediately erased, but the text is continuously displayed for a certain period of time is performed. A subsequent process is similar to that in the first embodiment.

With the process described above, the operation illustrated in FIG. 15 can be performed. In other words, the scenery seen by the viewer 911 via the HMD 300 is initially the screen 357 of FIG. 15. Then, if the viewer 911 looks at the product A, the screen 358 of FIG. 15 is displayed by the process of up to step S2416 of FIG. 20. Then, when the viewer 911 looks away from the display apparatus 400 and moves to another position, the screen 359 of FIG. 15 is displayed.

As described above, the present embodiment provides a display apparatus connected to a head mounted display including a display configured to display primary information, a projecting unit configured to project the primary information, or a signal output unit configured to output an image signal, a communication unit that is capable of performing communication with the head mounted display, and a staring point calculator configured to calculate position information of a staring point of a wearer of the head mounted display with respect to the primary information, wherein position information of the staring point of the wearer with respect to the primary information is calculated in accordance with a predetermined procedure on the basis of information received via the communication unit, secondary information related to the position information is selected, and when the position information is determined to be in a direction of the primary information, the secondary information displayed on the head mounted display is changed to be different from the secondary information when the position information is determined not to be in the direction of the primary information.

Accordingly, it is possible to obtain the supplement information which is unable to be obtained only from the broadcast content when the television is watched, to browse the secondary information even when the viewer look away from the television, and to increase the degree of freedom of the behavior of the viewer.

The present invention is not limited to the above-described embodiments and includes various modifications. For example, the above-described embodiments have been described in detail in order to facilitate understanding of the present invention and are not necessarily limited to those having all the components described above. It is also possible to add a configuration of another embodiment to a configuration of an embodiment. It is also possible to perform addition, deletion, and replacement of configurations of other embodiments on a part of the configurations of each embodiment.

### REFERENCE SIGNS LIST

100 projecting apparatus
110 signal input unit
120 controller (projecting apparatus)
130 display (projecting apparatus)
200 display apparatus
210 recording unit
220 controller (display apparatus)
230 signal output unit
240 communication unit (display apparatus)
250 staring point calculator
260 voice recognizing unit
270 manipulating unit
280 display (display apparatus)
300 head mounted display
310 imager
320 in-camera image staring point detector
330 voice acquiring unit
340 controller (head mounted display)
350 communication unit (head mounted display)
360 display (head mounted display)
400 display apparatus
410 IP communication unit
420 tuner
430 separator
440 display controller
450 display (display apparatus)
460 voice controller
470 speaker
510 primary information database
520 secondary information database
530 primary information
540 camera image
550 in-camera image staring point
560 audio data
570 secondary information
580 program identification information
590 secondary information database
910 teacher
911 viewer
920 student
930 screen
940 broadcasting equipment
950 transmitting antenna
960 Internet

1. A system, comprising:
a display apparatus; and
a head mounted display,
wherein the display apparatus includes
a first display that is capable of displaying an image or a projecting unit that is capable of projecting an image, and
a first communication unit that is capable of performing communication with the head mounted display,
the head mounted display includes
a second display configured to display an image which is viewed by a wearer of the head mounted display,
a line of sight detector configured to detect a line of sight direction of the wearer of the head mounted display, and
a second communication unit that is capable of performing communication with the display apparatus,
a staring point detector configured to detect a position of a staring point of a line of sight of the wearer of the head mounted display with respect to the image displayed by the first display of the display apparatus or the image projected by the projecting unit on the basis of information transmitted and received via the first communication unit and the second communication unit is installed in either of the display apparatus and the head mounted display,
the staring point detector calculates position information in the image corresponding to the position of the staring point when the staring point is on the image, and
the head mounted display acquires relevant data related to target data displayed at the calculated position in the image by means of the communication with the display apparatus or other communication and displays the relevant data on the second display.

2. The system according to claim 1, wherein the head mounted display changes a display layout or a display menu in the second display when the staring point detector determines that the staring point is on the image to be different from a display layout or a display menu when the staring point detector determines that the staring point detector is not on the image.

3. A head mounted display cooperative display system, comprising:
a display apparatus; and
a head mounted display,
wherein the display apparatus includes
a first display configured to display primary information, a projecting unit configured to project the primary information, or a signal output unit configured to output an image signal,
a first communication unit that is capable of performing communication with the head mounted display, and
a staring point calculator configured to calculate position information of a staring point of a wearer of the head mounted display with respect to the primary information,
the head mounted display includes
a second display configured to display secondary information which is viewed by the wearer,
a second communication unit that is capable of performing communication with the display apparatus,
an imager configured to capture a camera image in a direction in which the wearer faces, and
an in-camera image staring point detector configured to detect a staring point of the wearer with respect to the camera image, and
the display apparatus calculates position information of a staring point of the wearer with respect to the primary information by the staring point calculator on the basis of the detected staring point transmitted and received via the first communication unit and the second communication unit, selects the secondary information related to the position information, and changes a display method of the secondary information in the second display when the position information is determined to be in the primary information to be different from a display method when the position information is determined not to be in the primary information.

4. The head mounted display cooperative display system according to claim 3, wherein the staring point calculator calculates the position information of the staring point of the wearer of the head mounted display with respect to the primary information by specifying a display region of the primary information in the camera image, deriving a conversion formula on the basis of coordinates on the specified display region corresponding to coordinates specific to the primary information, and performing coordinate conversion of the staring point of the wearer of the head mounted display in the camera image.

5. The head mounted display cooperative display system according to claim 4, wherein by detecting an identification image arranged on the coordinates specific to the primary information, the display region of the primary information is specified, and the conversion formula is derived.

6. The head mounted display cooperative display system according to claim 3, wherein the staring point calculator calculates the position information of the staring point of the wearer of the head mounted display with respect to the primary information when the staring point of the wearer of the head mounted display in the camera image is staying at a certain position.

7. The head mounted display cooperative display system according to claim 3, wherein, when the position information is determined not to be in a direction of the primary information, a period of time until the secondary information is erased is changed in accordance with an attribute of each piece of secondary information.

8. The head mounted display cooperative display system according to claim 3, wherein, when the position information is determined not to be in a direction of the primary information, transmittance for display the secondary information is changed in accordance with an attribute of each piece of secondary information.

9. The head mounted display cooperative display system according to claim 3, wherein the display apparatus includes a voice recognizing unit configured to convert audio data into a text, the head mounted display includes a voice acquiring unit configured to acquire a sound around the wearer of the head mounted display, and the display apparatus displays secondary information related to the keyword when a specific keyword is detected in the text.

10. A display apparatus connected to a head mounted display, comprising:
a display configured to display primary information, a projecting unit configured to project the primary information, or a signal output unit configured to output an image signal;
a communication unit that is capable of performing communication with the head mounted display; and
a staring point calculator configured to calculate position information of a staring point of a wearer of the head mounted display with respect to the primary information,
wherein position information of the staring point of the wearer with respect to the primary information is calculated in accordance with a predetermined procedure on the basis of information received via the communication unit,
secondary information related to the position information is selected, and
when the position information is determined to be in a direction of the primary information, the secondary information displayed on the head mounted display is changed to be different from the secondary information when the position information is determined not to be in the direction of the primary information.

11. The display apparatus according to claim 10, further comprising:
a tuner configured to receive the primary information;
a separator configured to separate various kinds of signals included in the primary information and acquires information identifying the primary information; and
an IP communication unit configured to receive a database in which secondary information related to the primary information is described via a communication network.
